(19) United States
(12) Patent Application Publication
(10) Pub. No.: US 2009/0311409 A1
(43) Pub. Date: Dec. 17, 2009

(54) Food Compositions, Process for Preparing Food Compositions and Products

(76) Inventors: Valdecir Luccas, Cotia-Sao Paulo (BR); Priscilla Efraim, Cotia-Sao Paulo (BR); Fernanda Zaratini Vissotto, Cotia-Sao Paulo (BR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/295,806

(22) PCT Filed: Apr. 3, 2007
(86) PCT No.: PCT/BR2007/000079

§ 371 Date: Jun. 8, 2009

Related U.S. Application Data
(60) Provisional application No. 60/865,675, filed on Nov. 14, 2006.

(30) Foreign Application Priority Data
Apr. 3, 2006 (BR) PI0601145-4
Nov. 3, 2006 (BR) PI0604530-8
Dec. 11, 2006 (BR) PI0605208-8

(51) Int. Cl. A23G 1/00; A23G 1/04

(52) U.S. Cl. 426/584; 426/593; 426/631

(57) ABSTRACT

The present invention relates to food compositions comprising composition of cocoa and/or derivatives thereof and a fat-substitute protein having a reduced fat content, being preferably light in fat and/or having a reduced caloric value without addition of sugar. The present invention also relates to methods of preparing said food compositions and to products comprising them.

### TECHNICAL FIELD

The present invention refers to a food composition with reduced fat content, preferably “light”, comprising composition of cocoa and/or derivative thereof, and a fat-substitute protein, such as hydrolyzed collagen, said composition can be a chocolate, as well as the process for preparing said composition and a product comprising the same.

This invention also refers to a food composition that comprises a composition of cocoa and/or derivatives thereof, and fat-substitute protein such as hydrolyzed collagen, presenting reduced fat content and reduced caloric value without the addition of sugar, like a chocolate, preferably light in fat and reduced by at least 25% in calories, and a process for preparing said composition and a product comprising the same.

### STATE OF THE ART

The occurrence of obesity and the number of people considered overweight has progressively risen due to food habits based on high fat content and caloric value food. Since this form of nutrition is usually associated with different diseases such as cardiac diseases, diabetes and hypertension, it has been found an interest to reduce it in the population's diet.

It is known that concern by consumers and health organization is crescent in having more nutritious and healthier food, such as light and calorie reduced food, aimed at a more pleasant esthetic and more favorable health condition.

To this end, considering that the ingestion of food with high fat content can bring serious problems such as an undesirable weight gain, accumulation of fat in the body, obesity, heart problems, among others, the market is dedicated to developing reduced-fat content foods.

In this scenario, the consumer market has shown itself more attentive to foods that aid in the reduction or control of calories and fat daily, and control body weight, leading the industry to develop new products considered as healthier to meet such demands.

Currently, many researches have been performed to obtain light foods, for instance, with reduced calories. However, results point to products, in special, those of chocolate base, with less fat, without at the same time present reduced caloric value, which can thus be considered as light in fats and calories.

It is known that chocolate is a food stuff of high nutritious and caloric value, with 100 grams providing on average 550 Kcal. Also, chocolate has a physical, chemical and rheological behavior determined by its flowing properties, humidity level, fat level, and distribution of the size of the particles of the paste.

Good quality chocolate should be hard and brittle between 20 to 25° C., quickly and completely melt in the mouth without fatty residue or arenose/grainy sensation during or after degustation. In terms of process, it should show present rheological properties suited to manufacturing lines and good contracting properties during removal from its mold.

Currently, majority of chocolates are produced from milled sugar, deodorized cocoa butter, natural cocoa liquor, skimmed milk powder, butter oil, soy lecithin, polyglycerol polyricinoleate (PGPR) and vanilla aroma, or similar elements. Conventionally, process for obtaining chocolate involves the stages of mixing ingredients, refinement, shelling, tempearing, molding, cooling, removing from mold, and packing.

In addition to the conventional chocolate production mentioned, today there is also, thanks to technological food advancements, the production of chocolates which besides their already known properties have components that aims aiding the maintenance of the consumers' health.

Chocolate-containing foods, specially bars and chocolate bom-bons, are much popular either because they are products greatly accepted by popular taste in general, or because they are considerably convenient for snacks or as complement to meals. Likewise, chocolate bars used in coating products and others such as cakes, tarts and bakery products in general also have a great share of the market. Conventionally, fat contents in these foods are above 28% in weight and the caloric value exceeds 150 kcal in each portion of 30 g of the product.

An example of the state of the art for a chocolate based food and its respective process of manufacturing can be found in GB 1.538.750, which describes a chocolate based food and a method for its preparation. The chocolate based food includes cocoa solids, cocoa butter, sugar, a starch and/or gelatinizing agent, and preferably an emulsifier, where the cocoa butter is present in individual particles separated from each other in an aqueous sugar solution. Thus, a substantially discontinued fat phase is provided. The chocolate preparation process involves the stages of (i) mixing ingredients (water, sugar, cocoa solids, cocoa butter, a starching or gelatinizing agent and an emulsifying agent to allow the emulsion of the cocoa butter in an aqueous sugar solution), (ii) keep the cocoa butter emulsified in the solution, so that enough water evaporates from the solution to prevent separation of the cocoa butter from the solution, and (iii) allow the starching or gelatinizing agent to produce a chocolate food where the cocoa butter particles are dispersed in the aqueous sugar solution, providing a discontinuous fat phase.

As mentioned, GB 1.538.750 describes a chocolate based product and its manufacturing process, but fails to mention any caloric reduction when compared with the currently available chocolate based products in the market.

In this aspect, document JP 2005-328842 proposes a food item enriched in collagen, and which when ingested, activates support tissues such as skin, bones and cartilage, this food being either chocolate or gelatin. More specifically, this document, through the food stuff that please consumer taste (chocolate and jelly), is aimed at offering nutrients to benefit support tissues and consequently, one's health. However, document JP 2005-328842 does not describe or suggest that the food has reduced fat content, neither describes or suggests that the presence of collagen in the food's composition is able to provide a food item with reduced fat, such as product light in fat. Also, benefits from the presence of a specifically hydrolyzed collagen, such as the ones that will be verified through the description of this invention, are also not mentioned in the Japanese document. However, in spite of demonstrating concern with health, at no moment does the Japanese document mention reduction of fat and/or calories, which can bring serious health problems such an undesirable weight gain, retention of fat in the body, obesity, heart problems, among others.

Document JP 2002-306077 describes a water-in-oil type hydrated chocolate, which presents soft buccal sensation similar to mousse or Bavarois, and allows long period of storage, comprising gelatin, whose aqueous solution at 5% in weight cannot be gelatinized when kept at 30° C., presenting water activity equal to or superior to 0.85. This document also describes a process for preparing the water-in-oil type hydrated chocolate including whipping, after emulsification, the chocolate paste and the water phase that contains said gelatin.

The Japanese document titled “Researches for the action mechanisms of proteins against efflorescence in chocolates (I)”, 2000, Vol. 21, No. 12 describes a chocolate composition including proteins, where various types of plant, animal and soy proteins are tested and their respectively anti-efflorescent effects evaluated.

The object of invention of this document only resembles the present invention in respect of a chocolate containing product since the focus of the previous technique is the action of the proteins against efflorescence in chocolate and not the improvement of eating habits with reduction in calories and/or fats.

Thus, it was found that there persists a market need for the supply of food compositions comprising cocoa and/or derivatives thereof such as chocolate with reduced fat content and at the same time reduced fat and calories, being a light food in fats, light in fat and calories, providing healthier food and of greater consumer interest.

In this scenario, the present invention provides food compositions of cocoa and/or derivatives thereof including hydrolyzed protein such as hydrolyzed collagen, presenting reduced fat, increased protein level and reduced caloric value without the addition of sugar, said compositions being preferably light in fat and calorie without the addition of sugar, and with beneficial physical-chemical properties unachieved by compositions known of the state of the art.

### OBJECTIVES OF THE INVENTION

It is therefore the first objective of this invention to provide a food composition such as chocolate, including a composition of cocoa and/or its derivatives that contain reduced fat level in relation to those known in the art, becoming healthier without changing the sensorial properties of the composition such as flavor and hardness to the bite, and cost equivalent to conventional compositions.

It is the second objective of the present invention to provide a process for preparing a food composition with reduced fat level such as the one mentioned above.

It is the third objective of this invention the use of a protein substituting fat such as hydrolyzed collagen, in a food composition based on composition of cocoa and/or derivatives thereof, aiming to provide reduced fat level in said composition.

It is the fourth objective of the present invention to provide a product including a food composition with reduced fat level such as the one mentioned above.

It is the fifth objective of this invention to provide a food composition such as chocolate, including a composition of cocoa and/or derivatives thereof that contain reduced fat level and reduced caloric value without the addition of sugar, particularly light in fat and calorie in relation to known of the art, making it healthier without changing the sensorial properties of the composition such as flavor and hardness to the bite, and cost equivalent to conventional compositions.

It is the sixth objective of the present invention to provide a process to prepare the food composition with a reduced fat and caloric value without the addition of sugar, such as it is mentioned above.

It is the sixth objective of the present invention the use of a protein to substitute fat such a hydrolyzed collagen, sweeteners and body agents in a food composition based on a composition of cocoa and/or its derivates, aimed at reduced fat level and caloric value without the addition of sugar in said composition for the preparation of a food composition with reduced fat and caloric value without the addition of sugar, as mentioned above.

It is the eight objective of the present invention to provide a product including the food composition with a reduced fat and caloric value level without the addition of sugar, such as it is mentioned above.

### BRIEF DESCRIPTION OF THE INVENTION

The first objective of the present invention is obtained from a food composition including a composition of cocoa and/or its derivates, a fat-substitute protein and emulsifying agents.

The second objective of the present invention is achieved through a process to prepare a food composition according to the one mentioned above including the following stages:

(i) Mixture of fat-substitute protein together with ingredients in powder of the food composition, followed by the cocoa liquor and cocoa butter;

(ii) Refinement of mass obtained in the stage (i);

(iii) shelling of the mass obtained in the stage (ii),

(iv) mixture of the mass obtained in stage (iii) together with the other ingredients of the composition.

The third objective of the present invention is achieved by the use of an effective quantity of a composition of cocoa and/or its derivates, a protein substituting fat and emulsifying agents to prepare a food composition such as the one mentioned above or obtained by the process as mentioned, providing a fat content varying from about 18 to 30% in weight in relation to the total weight of the composition.

The fourth objective is achieved through a product that includes a food composition such as the one mentioned above, or obtained by a process such as the one mentioned above.

The fifth objective of the present invention is obtained from a food composition including a composition of cocoa and/or its derivates, a fat-substitute protein and emulsifying agents, edulcorants and body agents.

The sixth objective is achieved through a process to prepare a food composition according to the one mentioned above including the following stages:

(i) mixture of fat-substitute protein together with ingredients in powder of the food composition, followed by the cocoa liquor and cocoa butter;

(ii) refinement of mass obtained in the stage (i);

(iii) shelling of the mass obtained in the stage (ii),

(iv) mixture of the mass obtained in stage (iii) together with the other ingredients of the composition.

The seventh objective of this invention is reached through the use of an effective quantity of a composition of cocoa and/or derivates thereof, hydrolyzed protein to substitute fat, emulsifiers and body agents for the preparation of a food composition such as the one mentioned above or obtained by the process as defined above.

The eighth objective of this invention is achieved through a product that includes a food composition such as the one mentioned above, or obtained by a process such as the one mentioned above.

### BRIEF DESCRIPTIONS OF THE FIGURES

This invention will be illustrated based on the following figures:

FIG. 1 illustrates the chart related to the tempering method in 3 stages for the first embodiment of the invention.

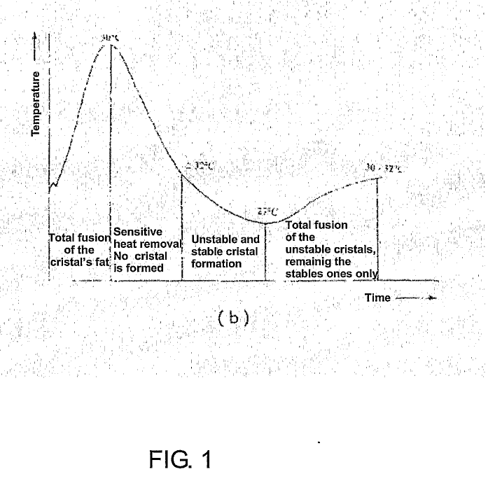

FIG. 2 illustrates curves related to shear rate, shear stress, for the first embodiment of the invention.

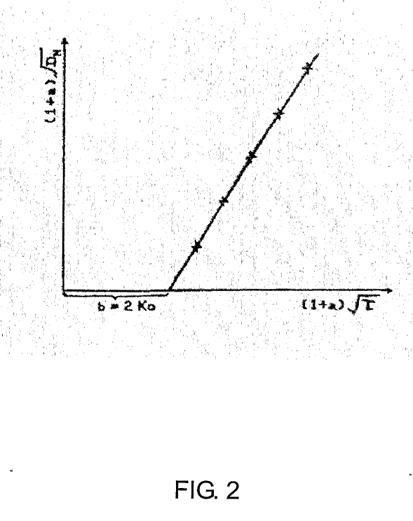

FIG. 3 illustrates cooling curve with typical curves from tempermeter: a) subtempered; b) slightly tempered; c) correctly tempered; d) super tempered, for a first embodiment of the invention.

FIG. 4 illustrates power×time curve from texture meter TA-XT2i, for the first embodiment of the invention.

FIG. 5 illustrates the chart related to the tempering method in 3 stages for the second embodiment of the invention.

FIG. 6 illustrates curves related to shear rate, shear stress, for the second embodiment of the invention.

FIG. 7 illustrates cooling curve with typical curves from tempermeter: a) sub-tempered; b) slightly tempered; c) correctly tempered; d) super-tempered, for a second embodiment of the invention.

FIG. 8 illustrates power×time curve from texture-meter TA-XT2i, for the second embodiment of the invention.

FIG. 9 illustrates profile of air temperature inside the cooling tunnel.

### DETAILED DESCRIPTION OF THE INVENTION

In the first embodiment, the present invention refers to a food composition with a composition of cocoa and/or derivates, a fat-substitute protein, such as hydrolyzed collagen and emulsifying agents, and optionally, milk.

The composition comprises about 25 to 40% composition of cocoa and/or derivates, about 2 to 10% fat-substitute protein such as hydrolyzed collagen, optionally about 10 to 30% milk, and about 0.5 to 3% emulsifiers in relation to total composition weight.

The composition of cocoa and/or derivates thereof can be in the form of mixture of cocoa derivates, cocoa powder, cocoa butter, cocoa liqueur or their mixture. Preferably, the composition should have at least 20% of cocoa solids for white chocolate and 25% of cocoa solids for milk chocolate.

The fat-substitute protein, preferably hydrolyzed collagen, can show different hydrolysis levels. Preferably, hydrolyzed collagen presents molecular weight of up to 50000 Da, more preferably between 500 and 30,000 Da, even more preferably between 1,500 and 20,000 Da.

The milk components and or derivate can be added to the formulation and chosen from skimmed, cow, whole, semi-skimmed, soy, condensed milks or their mixture, but not restricted to them. It is important that the type of milk allows fat reduction in the food composition as desired.

Emulsifying agents can be chosen from soy lecithin, PGPR, fatty acids esters, sorbitan monoestearate polyoxyethylene, phosphatidic acid ammonium, ricinoleic acid esters interesterified with polyglycerol, sorbitan monoestearate and sorbitan triestearate, and all classified as GMP (all additives included in Brazilian law regulating Good Manufacturing Practices) and their mixtures. The food composition preferably includes about 0 to 0.5% in PGPR weight and about 0-3% soy lecithin in relation to total composition weight.

The food composition preferably involves at about 20% in weight of total cocoa solids at least, e.g. to obtain white chocolate and at least 25% for milk chocolate.

The food composition comprises preferably about 18 to 30% in total fat weight and about 10% protein weight in relation to total composition weight. It also presents caloric value varying from 115 to 150 kcal per portion of 30 g.

The food composition, according to the invention, additionally comprises sugar. Sugar can be from milled sugar, granulated sugar, fructose, glucose, aspartame, sorbitol, xylose or their mixtures, being preferably milled sugar (in particle between 20 and 25 μm).

The food composition can also include cocoa butter, vegetable oils and animal fat.

The conservatives can be chosen from agents also accepted in the category for toppings and syrups for bakery products and biscuits, confectionaries, desserts, edible frozens, sweets, candy, bonbons and the like, and confectionary souse ready for consumption, such as: sorbic acid, sodium sorbate, potassium sorbate, calcium sorbate and those classified under GMP.

The aromas can be chosen from those conventionally known in the technique.

The composition of this invention may also include acidulants (citric and tartaric acids), aromatizers, stabilizers (carrageen, including ammonium salts, potassium and furcelaran), sugar coatings (all GMP, which are stearic acid and isomalt), and carnauba, and also, all GMP humectants (sodium lactate, potassium lactate, sorbitol and sorbitol syrup, manitol, glycerol, glycerin, xylitol, polydextrose).

The food composition presents one or more of the following characteristics:
humidity content varying between 0.4 and 1.2 in weight in relation to the total weight of the composition;
water activity varying about 0.36 to 0.39%;
size of particle varying in about 20 to 25 μm;
force of fracture varying from 2 to 2.6 kgf;
plastic viscosity of Casson varying in about 4 Pa·s to 11 Pa·s;
flowing limit varying from 0.3 to 1.5 Pa;
crystallization level varying from about 4.5 to 11 (Temperindex —TI);

The present invention also refers to a process to prepare a food composition as defined above that comprises the stages:

i) mixture of hydrolyzed collagen together with ingredients in powders of the composition of cocoa of said food composition;

(ii) refinement of mass obtained in the stage (i);

(iii) shelling of the mass obtained in the stage (ii),

(iv) mixture of the mass obtained in stage (iii) together with the other ingredients of the composition.

The process includes, in addition to the stages of tempering, the molding, removal from mold, and packing stages.

The present invention refers to an effective quantity of a composition of cocoa and/or its derivates, a fat-substitute protein and emulsifying agents providing a fat content varying in about 18 to 30% in weight in relation to the total weight of the composition, as defined above or obtained by the process defined previously.

In a second embodiment, the present invention refers to a food composition including a composition of cocoa and/or derivates, hydrolyzed fat-substitute protein, emulsifiers, edulcorants and body agents, with reduced fat content and caloric value, such as, for example, a chocolate light in fat and with reduced caloric value. The food composition optionally includes a component of milk and/or its derivates, hydrogenated fats and the equivalents/substitutes of cocoa butter and malt extract.

Preferably, said composition includes about 25 to 40% in weight of the composition of cocoa and/or other derivates, about of 1% to 10% in weight of hydrolyzed protein such as hydrolyzed collagen, about 0.1 to 5% in weight of emulsifiers, about 0.5 to 70% in weight of body agents, about 0.01 to 0.09% of edulcorant in relation to the total weight of the composition and optionally, up to 30% in weight of milk.

The composition (mass) of cocoa can be in the form of derivates of cocoa, cocoa powder, cocoa butter, cocoa liquor, or their mixture, but not limited to these examples. What is important is that it contains at least 25% of cocoa solids in its composition, e.g. for a milk chocolate and 20%, for instance, for a white chocolate. Alternatively, cocoa butter can be replaced by vegetable fats, butter oil and animal fat, cocoa butter substitutes and the like in general, in the quantity of 0.1 to 50% in weight in relation to the total weight of the composition.

The milk components and/or derivates (such as milk whey, for instance) can be added to the formulation and chosen from skimmed milk, whole milk, semi-skimmed milk, milk whey, milk substitute, cow milk, soybean milk, condensed milk or their mixture, but not restricted to them. It is important that the type of milk allows fat reduction in the food composition as desired.

The fat-substitute protein, preferably, can present different levels of hydrolysis, preferably of up to 50000 Da, more preferably between 500 and 30000 Da, even more preferably between 1500 and 20000 Da.

The emulsifiers can be chosen from soy lecithin, polyglycerol polyricinoleate (PGPR), esters from fatty acid, monoestearate polyoxythelene, phosphatidic acid ammonium salts, esters from ricinoleic acid interesterified with polyglycerol, sorbitol monoestearate and sorbitan triestearate, all classified as GMP and their mixtures, but not limited to these examples. The food composition preferably includes about 0 to 0.5% in PGPR weight and about 0 to 3% soy lecithin in relation to total composition weight.

The body agent can be chosen from polydextrose, lactotol, maltitol, sorbitol, fructogosaccharide, isomalt or their mixtures, but not limited to these examples.

The edulcorants can be chosen from sucralose, acesulfame-k, aspartame, saccharine, cyclamate, stevioside, or their mixtures, but not limited to them.

The aromas can be chosen from those conventionally known in the technique.

The fat source can be cocoa butter and or its substitutes/equivalents existing in the market, animal fat, hydrogenated fats, not restricted only to these examples.

The composition of this invention may also comprise acidulants (citric and tartaric acids), aromatizers, stabilizers (carrageen, including ammonium salts, potassium and furcelaran), sugar coatings (all GMP, which are stearic acid and isomalt), and carnauba, and also, all GMP humectants (sodium lactate, potassium lactate, sorbitol and sorbitol syrup, manitol, glycerol, glycerin, xylitol, polydextrose).

The conservatives can be from agents also accepted in the category for toppings and syrups for bakery products and biscuits, confectionaries, desserts, edible frozens, sweets, candy, bonbons and the like, and confectionary souse ready for consumption, such as: Sorbic acid, sodium sorbate, potassium sorbate, calcium sorbate and those classified under GMP.

The Food composition of the invention presents about 18% to 30% weight of total fat level in relation to the total weight of the composition and caloric value of about 50 to about 150 kcal per portion of 30 g of composition. The composition is preferably light in fat and calories.

This invention also refers to the use of an effective quantity of a composition of cocoa and/or its derivates, hydrolyzed protein to substitute fat, emulsifiers and body agents for the preparation of a food composition such as the one mentioned above or obtained by the process as defined above.

The present invention refers to a product that includes the food compositions defined above or obtained by process such as the one defined above. The product can be chocolate filled, topped, bonbons, fillings containing chocolate, bakery products such as breads, panettones and cakes. Favorite examples of food compositions of the invention is a chocolate that can be either a white or milk chocolate, assuming the shapes of tablet, bar, granulated, powder, sauce, filling, bars for toppings, among others.

The present invention will now be illustrated by examples, which do not limit the scope of the invention.

### Examples

It is described below a comparison between the food composition of this invention (with hydrolyzed collagen) and a conventional chocolate food (without added collagen):

TABLE 1
Formulations of standard milk chocolate (w/o added collagen)
and of light in fat milk chocolate (w/addition of collagen)

| | Standard chocolate | Chocolate - |
|---|---|---|
| Ingredients | (%) | light (%) |
| Milled sugar | 48.12 | 48.75 |
| Deodorized Cocoa butter | 20.00 | 12.14 |
| Natural cocoa liquor | 12.86 | 12.86 |
| Skimmed milk powder | 15.42 | 17.37 |
| HYDROGEL - hydrolyzed collagen | NOT CONTAINED | 4.94 |
| Butter Oil | 3.00 | 2.56 |
| Soy lecithin | 0.30 | 0.79 |
| Polyglycerol Polyricinoleate - PG- | 0.20 | 0.49 |
| PR | | |
| Vanilla aroma | 0.10 | 0.10 |
| Total fat level (%) | 30.00 | 22.44 |

In table 1 above, it is important to point out that for PGPR, 0.5% corresponds to the maximum level allowed by Brazilian law, while for soy lecithin there is no maximum limit established by the law.

According to Brazilian regulations, Resolution RDC 264, Sep. 22, 2005, it sets forth that “Chocolate is a product obtained from the mixture of cocoa derivates, paste (or paste or liquor) from cocoa, cocoa powder and or cocoa butter, with other ingredients, containing at least 25% (g/100 g) of total cocoa solids. The product may present varied fillings, toppings, shapes and consistence”. It is therefore allowed the incorporation of other ingredients to the chocolate paste, for instance, hydrolyzed collagen, ingredient proposition in the food composition of this invention, as long as within the minimum limits of total cocoa solids.

As established by Brazilian regulatory law, ordinance 27 of Jan. 13, 1998, technical regulation in reference to Complementary Nutritional Information for a product to be declared as light in fats, it should present reduction of at least 25% of the nutrient in question. Also under the ordinance, “the content of the nutrient and or energetic value of the food with which it is compared should be calculated based on a similar product of the manufacturer or of the average value of the content of three similar products known sold in the region; or also from a data base of recognized value”. Resolution RDC 360 of December 23, in its turn, that treats the technical Regulation on the nutritional Labeling of Packed Food Items, establishes in its Annex A, page 9, a daily reference value—VDF of 75 grams for proteins.

### Preparation Process of the First Embodiment of Food Composition of the Present Invention

The mixture of the ingredients was performed in a planetary blender of 5 liter capacity. The total fat level of standard chocolate (30%) was chosen based on the average value obtained on the labeling of three commercial samples of tablets used as reference. For the milk chocolate, it was initially mixed the ingredients in powder (milk powder and sugar), and then the cocoa liquor already melted with the part of cocoa butter (18.92%). The total fat level of the mixture in this stage was of 255, resulting in a paste of plastic consistence, suitable for refinement.

For the light milk chocolate were initially added the ingredients in powder, adding collagen, then liquor and all of the cocoa butter of the formulation. Thus, the changes in the mixing stages were tested: Addition of collagen in powder with the other ingredients in powder and the total incorporation of cocoa butter (12.14%).

As milled sugar was used in the formulation, the refinement of the paste was made in a single stage in a refiner composes of three horizontal sleeved cylinders in stainless steel, cooled with water. The distance between the cylinders was adjusted in such manner that the particle of the pastes stayed between 20 and 25 μm.

Shelling was conducted in two stages. Initially, dry shelling was made in a 5 kg shell. The paste was shelled at 60° C. for 10 hours. 3 kg lots were used. Next, the lot was divided in 700 gm fractions which were submitted to plastic shelling in a longitudinal minishell, PPC type (of Friwessa brand), bench size) of 1 kg capacity. The samples were shelled for 16 hours at 60° C. The soy lecithin and PGPR emulsifiers, together with the rest of the cocoa butter (only for standard chocolate), the butter oil and the vanilla aroma were incorporated into the paste in the beginning of the this stage. One must pointed out that industrially, emulsifiers are incorporated into chocolate at the final stage of the plastic shelling as due to its hydrophilic character they tend to hold the humidity and other volatile components of the product. However, in this procedure it was adopted based on the mechanical characteristics of the shell used (longitudinal shell).

The tempering was performed in a laboratory tempering device of 1 kg capacity. The tempering method was used in three stages proposed by TALBOT 9TALBOT, G. Chocolate temper. In: BECKET, S. T., (Ed.), Industrial chocolate manufacture and use 2nd ed. London: Chapman & Hall, 1994, chapter 11, pages 156-166).

Lots of 400 g were initially melted in a greenhouse with forced air circulation at 45 C and kept in the tempering device for 10 minutes at 40 C. This stage was necessary to promote stabilization in the temperature of the sampled before tempering. Next, the samples were cooled to 27.5 C, kept in this temperature for 10 minutes and heated again to 31° C. for 3 minutes, as presented in table 2 below:

TABLE 2
conditions used in the tempering process
of light standards milk chocolate samples

| | | Re-heating | |
|---|---|---|---|
| Crystallization tem- | Crystallization | temperature Tᵣ | Re-heating time |
| perature Tc (° C.) | Time t_{C} (min) | (° C.) | tᵣ(min) |
| 27.5 ± 0.5 | 10 | 31.0 ± 0.5 | 3 |

The use of a tempering device allowed standardization of tempering conditions (time and temperature) for the two formulations, preventing errors from manual tempering on a marble table.

The tempered samples were deposited in pre-heated molds and cooled in a conventional fridge at 10 C. During the tests were collected samples for the analysis of the crystallization levels. Both the tempering procedure and determination of the crystallization level were made in triplicate for each sample.

The mold removing stages and packing were made at 21±1° C. The chocolate bars were packed in aluminum paper and kept in a hermetic recipient, protected from humidity and light, within a chamber at controlled temperature of 20±1° C.

### Characterization of Samples:

Samples were characterized in terms of particle size, viscosity and flowing limit (Casson—IOCCC, International Office of cocoa, chocolate and sugar confectionery, Rev. Int. Choc. (RIC), v. 28, pages 216-218, 1973), water activity, humidity level, texture analysis (snap test) and crystallization level. Also performed sensorial analysis consisting of Acceptance Test (SAS Institute Inc. “Statistics analysis systems (SAS), Cary, USA, 1993).

All results were subject to variance analysis (ANOVA) and Tukey test to define the significant different between the averages of results using SAS program (Statistical Analysis System). Next, the methodologies used are presented.

Particle Size:

A micrometer of 0 to 250 μm scale was used, and which was verified before measurement. For each sample were taken 3 portions from different regions, diluted in pure mineral oil in approximately 1:1 weight ratio until the acquired homogenous consistence. 10 measurements were performed for each chocolate.

Humidity Level:

Measured by direct determination, by Karl Fischer (method 31.1.03, PROSKY, 2000). Approximately 0.4 g of chocolate were weighed in analytical scale and dissolved in chloroform:methanol solution 1:1. concentration of the reagent of Karl Fischer was performed. The determination was made in triplicate.

Water Activity—Aa

Direct determination by Hygrometers at constant temperature (25° C.±0.3° C.). The result presented is the average of nine determinations.

Viscosity and Limit of Casson Flowing

It was used a digital programmable rheometer with adaptor for small samples. The spindle used in the measurements was cylindrical, whose ratio of internal and external cylinder radii is of 0.75. The adaptor is coupled to a thermostat controlled bath and the sleeve temperature was kept at 40±0.5° C. during the readings. The measurements were performed using a rotation program present in table 3. With the results obtained and stored in the memory of the equipment, curves were raised correlating the rate of shearing with the tension of shearing, and the Casson parameters were calculated through linear regression. For each analysis were collected portions from different regions of the sample analyzed and three repetitions performed for each sample.

TABLE 3
Program used in the Rheometer

| Time | | Rotation |
|---|---|---|
| 3 | min* | 5 |
| 3 | min** | 50 |
| 3 | s. | 100 |
| 6 | s. | 50 |
| 15 | s. | 20 |
| 30 | s. | 10 |
| 60 | s. | 5 |
| 30 | s. | 10 |
| 15 | s. | 20 |
| 6 | s. | 50 |
| 3 | s. | 100 |

*Uniformization of sample temp.
**Sample pre-shearing

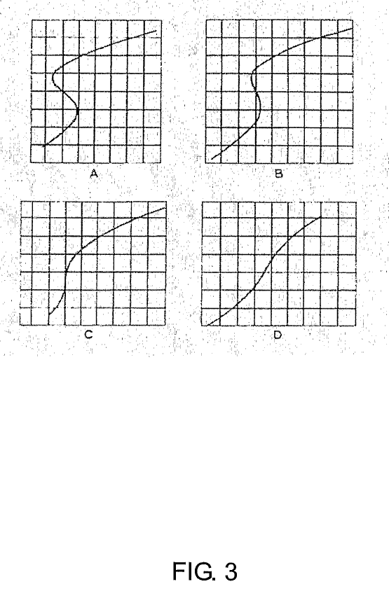

### See FIG. 3-Casson Rheogram

Crystallization Level

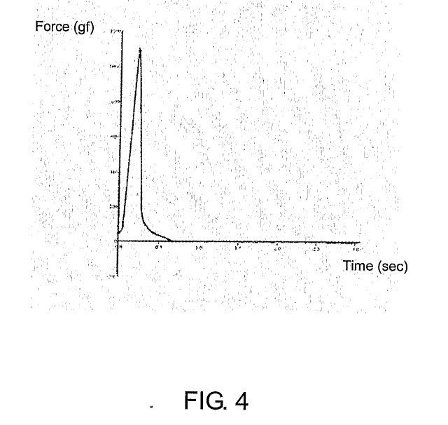

For the analysis of the crystallization level, a SOLLICH model E3 temper meter was used. The temperate samples were characterized according to the cooling curve (FIG. 4).

Snap Test (JORGE et al., 1999)

The analyses were performed in a Universal Texture meter TA-XT2i, of Stable Micro Systems, with attached software using probe HDP/3PB —THREE POINT BEND RIG. The conditions used for the analysis were:

Dimension of the chocolate bars: 8.2×2.5×0.7 cm
Bar paste: 19.27±1.40 g
Distance between probe bases: 6 cm
Distance between the probe and the sample: 5.5 cm
Pre-test speed: 3 mm/s
Test speed: 1.7 mm/s
Post-test speed: 10 mm/s

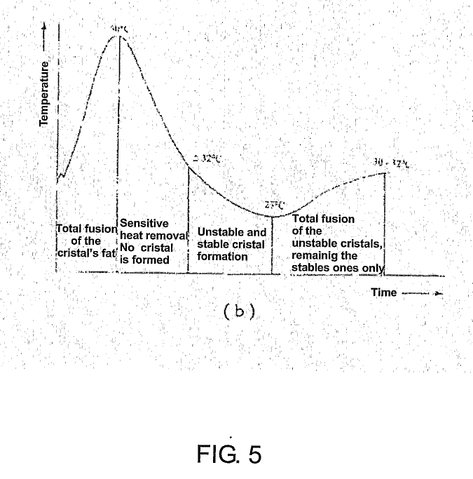

The parameter evaluated was the maximum snap force applied to the center of the bars, expressed in kgf, obtained through recording of the force—time curve, according to example presented in FIG. 5. the determinations were made in a temperature controlled environment at 25° C. 10 repetitions were made for each sample. See FIG. 5.

Sensorial Analysis

Consists of an acceptance test performed with 9 technicians of the cereal Chocotec, consumers of chocolate bars. The samples were evaluated for the attributes of hardness to bite and flavor, with a hedonic scale of nine points with opening for general remarks on the products. In addition to the indicated attributes, each taster gave a general grade for each sample.

### Results and Discussion

Table 4 shows the results of the humidity analyses, water activity and size of the particle of the milk chocolate samples of standard (w/o collagen), and light (w/collagen). The rheological parameters are presented on Table 5, along with the average correlation coefficients obtained.

TABLE 4
humidity, water activity and size of the particles of the samples
standard and light milk chocolate

| | | | Particle |
|---|---|---|---|
| Sample | Humidity* (%) | Water Activity* | size** (μm) |
| Standard chocolate | 0.48 ± 0.03^{b} | 0.37 ± 0.01^{a} | 21.60 ± 0.71a |
| Chocolate - light | 0.79 ± 0.04a | 0.38 ± 0.01a | 23.00 ± 1.83a |
| MDS | 0.04 | 0.05 | 2.15 |

*Average of 3 repetitions ± standard deviation
**Average of 10 repetitions ± standard deviation
MDS: Minimum Relevant Difference
Values of the same column with the same letter do not substantially differ from each other through Tukey test by 5% of relevance.

TABLE 5
Rheological parameters and average coefficients of correlation of
standard and light milk chocolate samples

| | (Pa · s) • | | | |
|---|---|---|---|---|
| Sample | ηca* | τca** (Pa) • | R2*** • | T (° C.) • |
| Standard | 4.04 ± | 0.89 ± 0.12 a | 0.9934 ± 0.0022 | 40.0 |
| Chocolate | 0.14^{b} | | | |
| Chocolate - | 10.45 ± | 0.41 ± 0.07^{b} | 0.9919 ± 0.0036 | 40.0 |
| light | 0.39^{b} | | | |

*Average of 3 repetitions ± standard deviation
*ηca - Casson plastic viscosity
**τca - Casson flowing limit
***R2 - Variation coefficient

The level of humidity, the activity of water, and the size of the particle of the chocolates are directly related to the conditions of the process. It is verifies on Table 4 that the values of the size of the particle for the two samples of milk chocolate, standard and light, remained within the suitable range for this measure, i.e. between 20 and 25 μm. Larges sizes than 25 μm give arenose taste in the mouth when tasting the chocolate, while sizes inferior to 20 μm can cause technological problems as they lead to increased viscosity and flowing limit, hindering the subsequent processes (BECKETT, 1994; MINIFFIE, 1989).

The low humidity values and activity of water obtained indicate that the process used, the shelling time of 16 hours was enough to reduce the initial humidity present in raw materials at desired levels (less than 2%). These results show that there is no need for extra drying of the Hydrolyzed Collagen—HIDROGEL®. There was no statistically significant difference to the level of 5% between samples for the 3 parameters analyzed.

The partial replacement of cocoa butter by HIDROGEL® hydrolyzed collagen in proportion of 4.94%, and the consequent reduction of the lipid level of the formulation (of 30% in standard milk chocolate for 22.44% in light chocolate) cause a reduction in the flowing limit from 0.89 Pa to 0.41 Pa and an increase in viscosity of samples from 4.04 Pa·s to 10.45 Pa·s Even so, the combined use of emulsifiers (PGPR and soy lecithin) allowed the obtained of products with rheological parameters close to the ones presented by the similar chocolates sold in Brazil without the substitution of fat.

The molding, cooling and removal of light-in-fat milk chocolate were performed the same as for standard milk chocolate and both products presented shine and absence of air bubbles.

Table 6 presents the results obtained in the tempering or pre-crystallizing of samples, while table 7 shows the results of the snap test of chocolate bars.

TABLE 6
Results obtained in the tempering of standard and light milk
chocolate samples - analyses conducted at the temperature
of 20.0 ± 0.7° C.

| | | Crystallization level* |
|---|---|---|
| Sample | Cooling rate (° C./min)* | (Temperindex - TI) |
| Standard chocolate | 1.50 ± 0.18 a | 5.97 ± 0.13 a |
| Chocolate - light | 1.27 ± 0.13 a | 6.10 ± 0.22 a |
| MDS | 0.36 | 1.32 |

*Average of 3 repetitions ± standard deviation
MDS: Minimum Relevant Difference
Values of the same column with the same letter do not substantially differ from each other through Tukey test by 5% of relevance.

TABLE 7
Snap force of the samples of standard milk chocolate
(w/o collagen) and light milk chocolate (w/ collagen)

| Sample | Fracture force (kgf)* |
|---|---|
| Standard chocolate | 2.391 ± 0.231^{a} |
| Chocolate - light | 2.424 ± 0.224^{a} |
| MDS | 0.265 |

*Average of 3 repetitions ± standard deviation
MDS: Minimum Relevant Difference
Values of the same column with the same letter do not substantially differ from each other through Tukey test by 5% of relevance.

Note on table 6 that statistically significant differences of up to 5% were not identified for the two chocolate samples in terms of crystallization level. The values of the Temperindex found are quite close to the ideal value for milk chocolate of 5.0. The similarity in the values of the Temperindex can indicate that the incorporation of 4.94% of Hydrolyzed Collagen did not negatively influence the formation and growth of cocoa crystals, allowing the formation of a crystalline coarse and compact network. However, it is important to point out that the more conclusive results can only be obtained by extra trials using specific analytical techniques such as diffraction of X rays and differential sweep calorimetry (DSC). The results obtained from crystallization suggest that industrially, tempering of light milk chocolate, formulated with collagen can be performed using the tradition processes used for chocolates with pure cocoa butter (TALBOT, 1994).

Table 7 shows the results of the snap force of the samples. It is noted that the values for the 2 milk chocolates, standard and milk were quite close, being a little higher for light in fat chocolate probably due to its reduced fat level. According to TIMMS (1980), the main cause off softening in milk chocolate is the slow down of the crystallization process of cocoa butter caused by the presence of milk fat, as both have very distinct triglyceride compositions. This softening, or esthetic effect is many times undesired as it reduces and makes it more susceptible to the occurrence of fat bloom, or migration of fatty phase to the product surface.

Table 8 shows the average values obtained in the sensorial evaluation of chocolate samples.

The grades awarded by 9 tasters in this example are based on the following classification:
Hardness to bite: Varying from 1 to 9, where 1=soft, 5=intermediary, 9=hard;
Melting: Varying from 1 to 9, where 1=bad, 5=intermediary, 9=optimum;
Residual in mouth: Varying from 1 to 9, where 1=very residual, 5=intermediary, 9=absent;
Taste: Varying from 1 to 9, where 1=bad, 5=good, 9=optimum;
General grade: Varying from 1 to 9, where 1=bad, 5=good, 9=optimum.

TABLE 8
Average values obtained in the sensorial evaluation of milk chocolate
samples standard and light

| | Hardness | | Residual in | | General |
|---|---|---|---|---|---|
| Sample | to bite | Melting | mouth | Taste | grade |
| Standard | 6.73 ± 1.06a | 5.76 ± 1.36a | 5.61 ± 2.70a | 7.12 ± 1.58a | 6.80 ± 1.16a |
| Chocolate | | | | | |
| Chocolate - Light | 6.16 ± 1.82a | 5.60 ± 1.30a | 5.00 ± 2.30a | 6.01 ± 1.41^{b} | 6.12 ± 1.16a |
| MDS | 1.15 | 1.09 | 1.10 | 0.74 | 1.23 |

* Average of 3 repetitions ± standard deviation
MDS: Minimum Relevant Difference
Values of the same column with the same letter do not substantially differ from each other through Tukey test by 5% of relevance.

It is verified for all attributes considered in the acceptance test (hardness to bite, melting, residual in mouth, taste and general grade) there was statistically no significant difference between samples of standard and light milk chocolates. The major differences (but insignificant) were noted for melting and residual in mouth. The result of the attribute of “bite hardness” confirms the similarity in the snap force parameter for the two samples, as already presented in Table 7. This means that the presence of 4.94% of collagen was not noted by majority of tasters.

It is important to point out that in this design the chocolate samples were produced in a pilot scale. Depending on the equipment used industrially, especially at the shelling stage, it is quite common to expect global quality of the product to be superior as other shells have more effective systems of ingredient homogeneity, with better involvement of solid particles of sugar, milk and collagen by the fatty phase, in addition to promoting a more effective elimination of undesirable aromas during the process.

Table 9 brings nutritional information comparing between samples developed (standard and light), and the three chocolate samples chosen by the company to be used as reference for the calculation of the fat level, as established by the law.

TABLE 9
Nutritional comparison of samples

| | | | | | | | Standard | | Chocolate - | |
|---|---|---|---|---|---|---|---|---|---|---|
| | Nestlé 30 g | | Kraft 30 g | | Garoto | | chocolate | | light 30 g | |
| Information | Portion | | Portion | | 30 g Portion | | 30 g Portion | | Portion | |
| Carbohydrates | 18 | g | 17 | g | 17 | g | 17 | g | 18 | g |
| Proteins | 2 | g | 2 | g | 3 | g | 2.1 | g | 3.6 | g |
| Total fat | 9 | g | 9 | g | 9 | g | 9 | g | 6.7 | g |
| Saturated fat | 5 | g | 5 | g | 5 | g | 5.8 | g | 4.2 | g |
| Fiber | <1 | g | <1 | g | <1 | g | <1 | g | <1 | g |
| Calcium | 44 | mg | 60 | mg | 88 | mg | 61 | mg | 69 | mg |
| Iron | 0.49 | mg | 0.5 | mg | 0.24 | mg | 0 | | 0.05 | |
| Sodium | 0 | mg | 40 | mg | 0 | mg | 20 | mg | 23 | mg |
| Cholesterol | 5 | mg | <5 | mg | <5 | mg | <5 | mg | <5 | mg |
| Caloric value | 160 | Kcal | 160 | Kcal | 160 | Kcal | 158 | Kcal | 146 | Kcal |

Adopting the level of total fats of the 3 commercial samples (Nestle, Kraft and Garoto) as reference, which is of 8.67% (portion of 30 grams), one notes that in Table 9 the total fat of the light chocolate developed was off 6.4%, i.e. there was reduction of 26.18%. As specified in Brazilian Ordinance 27, the product can be declared as being light in total fats.

In relation to the level of proteins (average of 2.3 g/30 g sample in the commercial samples), the light chocolate produced with collagen has 3.6 g/30 g sample, i.e. 56% more than when compared to commercial chocolates.

It is verified that the caloric reduction of the light chocolate was of 8.8%, i.e. 146 Kcal/30 g against the average 160 Kcal/30 g of commercial chocolates. The product cannot therefore be considered light in calories.

Table 10 shows a comparison between the costs of the two formulations.

It is verified that the values were equal for both chocolates, indicating that the incorporation of hydrolyzed collagen HIDROGEL did not change the cost of the product.

TABLE 10
Comparison between the costs* of the milk chocolates - standard
and light

| | | | Cost* of | | |
|---|---|---|---|---|---|
| | | Standard | Standard | | Cost* of |
| | | chocolate | chocolate | Chocolate - | Light chocolate |
| Ingredients | Price/Kg | (%) | (R$) | light (%) | (R$) |
| Milled sugar | 0.92 | 48.12 | 0.44 | 49.36 | 0.45 |
| Deodorized | 15.10 | 19.70 | 2.97 | 12.14 | 1.83 |
| Cocoa butter | | | | | |
| Natural cocoa | 7.50 | 12.00 | 0.90 | 11.85 | 0.89 |
| liquor | | | | | |
| Skimmed milk | 8.50 | 16.58 | 1.41 | 17.37 | 1.48 |
| powder | | | | | |
| HYDROGEL - | 20.71 | NOT | 0.00 | 4.94 | 1.02 |
| hydrolyzed | | CONTAINED | | | |
| collagen | | | | | |
| Butter Oil | 12.00 | 3.00 | 0.36 | 2.96 | 0.36 |
| Soy lecithin | 3.32 | 0.30 | 0.01 | 0.79 | 0.03 |
| Polyglycerol | 13.06 | 0.20 | 0.03 | 0.49 | 0.06 |
| Polyricinoleate - | | | | | |
| PGPR | | | | | |
| Vanilla aroma | 40.00 | 0.10 | 0.04 | 0.10 | 0.04 |
| TOTAL | | 100.00 | 6.16 | 100.00 | 6.16 |

*calculations made for 1 kg of product/Already considering the taxes/São Paulo Post - Commercial dollar = R$2,375 on 19/Dec/2005

In the conditions of the process used, the following conclusions can be deduced:

Light in total fats chocolate presented 56% more protein when compared to commercial chocolates used as reference;

The use of 4.94% of collagen associated with soy lecithin and PGPR did not interfere in the processing conditions;

Sensorialy, there were no statistically significant differences of up to 5% identified between standard and light milk chocolates developed.

TABLE 11
Formulation of standard and light in fat and calories milk
chocolates

| | | Chocolate - |
|---|---|---|
| | Standard | light and |
| | chocolate | diet |
| Ingredients | (%) | (Example I) (%) |
| Milled sugar | 48.12 | 0 |
| Deodorized Cocoa butter | 20.00 | 12.14 |
| Natural cocoa liquor | 12.86 | 12.86 |
| Skimmed milk powder | 15.42 | 17.34 |
| HYDROGEL - hydrolyzed collagen | NOT | 4.94 |
| | CONTAINED | |
| Butter oil | 3.00 | 2.56 |
| Soy lecithin | 0.30 | 0.79 |
| Polyglycerol Polyricinoleate - PGPR | 0.20 | 0.49 |
| Vanilla aroma | 0.10 | 0.10 |
| Polydextrose | 0 | 20.5 |
| Maltitol | 0 | 28.21 |
| Sucralose | 0 | 0.062 |
| Total fat level (%) | 30.00 | 22.44 |

TABLE 12
Examples of alternative chocolate formulations with fat and
caloric reduction by use of hydrolyzed collagen

| | Chocolate - light and | Chocolate - light and |
|---|---|---|
| Ingredients | diet (Example II) (%) | diet (Example III) (%) |
| Milled sugar | 0 | 0 |
| Deodorized Cocoa butter | 12.14 | 12.14 |
| Natural cocoa liquor | 12.86 | 12.86 |
| Skimmed milk powder | 17.34 | 17.34 |
| HYDROGEL - | 4.94 | 4.94 |
| hydrolyzed collagen | | |
| Butter oil | 2.56 | 2.56 |
| Soy lecithin | 0.79 | 0.79 |
| Polyglycerol | 0.49 | 0.49 |
| Polyricinoleate - PGPR | | |
| Vanilla aroma | 0.10 | 0.10 |
| Polydextrose | 13.0 | 32.0 |
| Maltitol | 35.75 | 16.74 |
| Sucralose | 0.026 | 0.035 |
| Total fat level (%) | 22.44 | 22.44 |

Table 13 below brings the comparative nutritional information between the standard sample (w/o fat and caloric reduction and w/o hydrolyzed collagen use), and the 3 examples mentioned on the tables above, with reduction of fat and calories, and use of hydrolyzed collagen, and the three samples of chocolate chosen by the applicant to be used as reference for the calculation of the level of fat and calories of bar chocolate for direct consumption, as established by Brazilian law.

TABLE 13
Nutritional comparison of samples - chocolate in bar for direct
consumption

| | | | | | | | | | Chocolate - Light |
|---|---|---|---|---|---|---|---|---|---|
| | Nestlé | | Kraft | | Garoto | | Standard | | and Diet (Examples |
| | 30 g | | 30 g | | 30 g | | chocolate | | I/II/III) 30 g |
| Nutritional Information | Portion | | Portion | | Portion | | 30 g Portion | | portion |
| carbohydrates | 18 | g | 17 | g | 17 | g | 17 | g | 13.8/13.8/13.8 |
| Proteins | 2 | g | 2 | g | 3 | g | 2.1 | g | 3.6 g/3.6 g/3.6 g |
| Total fat | 9 | g | 9 | g | 9 | g | 9 | g | 6.73 g/6.73 g/ |
| | | | | | | | | | 6.73 g |
| Saturated fat | 5 | g | 5 | g | 5 | g | 5.8 | g | 4.2/4.2/4.2 |
| Fiber (g) | <1 | g | <1 | g | <1 | g | <1 | g | 4.5/4.5/4.5 |
| Calcium (mg) | 44 | | 60 | | 88 | | 61 | | 70/70/70 |
| Iron (mg) | 0.49 | | 0.5 | | 0.24 | | 0 | | 0.48/0.48/0.48 |
| Sodium (mg) | 0 | | 40 | | 0 | | 20 | | 24/24/24 |
| Cholesterol | 5 | mg | <5 | mg | <5 | mg | <5 | mg | <5 mg |
| Caloric value | 160 | | 160 | | 160 | | 158 | | 114/117/109 |
| (Kcal) | | | | | | | | | |

Table 14 is similar to table 13, bringing however examples of bar chocolates for toppings existing in the market.

TABLE 14
Nutritional comparison of samples - bar chocolate for topping w/o
collagen and bar chocolate for topping with added hydrolyzed collagen

| | Nestlé | | | | | | | |
|---|---|---|---|---|---|---|---|---|
| | 30 g | | Kraft | | Garoto | | Chocolate in bar for | |
| Nutritional Information | Portion | | 30 g Portion | | 30 g Portion | | light and Diet topping | |
| carbohydrates | 16 | g | 17 | g | 17 | g | 13.8 | g |
| Proteins | 2 | g | 3 | g | 2 | g | 3.6 | g |
| Total fat | 10 | g | 9 | g | 10 | g | 6.73 | g |
| Saturated fat | 6 | g | 5 | g | 6 | g | 4.2 | g |
| Fiber | 1 | g | 0 | | 0 | | 4.5 | g |
| Calcium | 65 | mg | 95 | mg | 59 | mg | 70 | mg |
| Iron | 0.37 | mg | * | | 0.3 | mg | 0.48 | mg |
| Sodium | 0 | mg | 55 | mg | 0 | mg | 24 | mg |
| Cholesterol | <5 | mg | 5 | mg | 0 | | <5 | mg |
| Caloric value | 160 | Kcal | 160 | Kcal | 160 | Kcal | 117 | Kcal |

* insignificant quantity

The total fat level of standard chocolate (30.00%) was chosen based on the average value obtained on the labeling of three commercial samples of milk chocolate tablets NESTLÉ, KRAFT and GAROTO. Table 2 shows formulations of standard milk chocolate w/o added collagen and of light in fat milk chocolate w/added collagen. In the light chocolate, the sugar was replaced by a mixture of maltitol and polydextrose. For the correction of the sweetness of the product, sucralose was used. The total fat level calculated for light chocolate was of 22.44%.

TABLE 15
Formulation of standard and light in fat and caloric milk
chocolates with collagen

| | Standard | Chocolate - light in fats |
|---|---|---|
| | chocolate | and light in |
| Ingredients | (%) | calories (%) |
| Milled sugar | 48.12 | — |
| Maltitol | — | 35.75 |
| Deodorized Cocoa butter | 20.00 | 12.14 |
| Skimmed milk powder | 15.42 | 17.37 |
| Polydextrose | — | 13.00 |
| Natural cocoa liquor | 12.86 | 12.86 |
| HYDROGEL hydrolyzed collagen | — | 4.94 |
| Butter Oil | 3.00 | 2.56 |
| CHOCOLEC Soy lecithin | 0.30 | 0.79 |
| Polyglycerol Polyricinoleate - | 0.20 | 0.49 |
| PGPR | | |
| Vanilla aroma | 0.10 | 0.10 |
| Sucralose | — | 0.026* |
| Total | | |
| Total fat level (%) | | |

— Does not contain;
*on the total weight of the formulation

HYDROGEL hydrolyzed collagen used in the invention can be obtained from Gelita under the commercial name Instant Gel.

### Preparation Process of the Second Modality of Food Composition of the Present Invention

The mixture of the ingredients was performed in a mixer/shell (INCO brand) of 5 kg capacity.

This stage was conducted under temperature of 40° C., kept by circulation of hot water in equipment sleeve. 3 kg lots of the product were used.

For standard milk chocolate, the ingredients of sugar and milk powder were initially mixed. Next, cocoa liquor and a part of cocoa butter were mixed (until completing 25% of total fat), previously melted at 40° C. The mixture led to a plastic consistence suitable for refinement. For the light milk chocolate were initially added the ingredients in milk powder, maltitol, polydextrose, collagen and sucralose, then cocoa liquor and all of the cocoa butter of the formulation (12.14%) previously melted at 40° C.

The refinement of the mass was made in a single stage in a DRAISWERK refiner, GMBH model, comprised of 3 horizontal cylinder sleeves in stainless steel, cooled by cold water. The distance between the cylinders was adjusted to obtain the maximum size pf paste particles between 20 and 25 μm measured with a digital micrometer. The tempering method was used in three stages proposed by TALBOT (FIG. 5).

Shelling was made in a longitudinal minishell, FRIWESSA brand, PPC type, of 1 kg capacity. The samples were shelled for 24 hours at 60° C. Based on the mechanical characteristics of the shell, it was not possible to perform the dry shelling. The paste from the refinement received the rest of the cocoa butter (for the standard milk chocolate only), and the soy lecithin ingredients, PGPR and vanilla aroma, previously mixed in butter oil to facilitate dispersion. Lots of 700 grams were worked with for each formulation.

It is important to point out that for majority of the industrial shells with different operation principles from the longitudinal shell, it is recommended the incorporation of emulsifiers by the end of the shelling process, approximately 30 minutes before the termination of this stage.

The tempering was performed in a lab tempering device, ACMC brand model D45134 of 1 kg capacity.

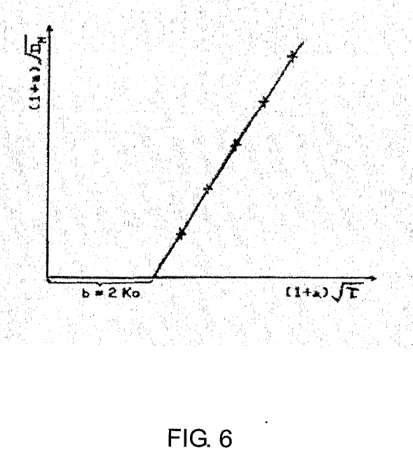

The tempering method was used in three stages proposed by TALBOT (FIG. 6, 1994).

Lots of 400 g were initially melted in a greenhouse with forced air circulation at 45° C. and kept in the tempering device for 10 minutes at 40° C. This stage was necessary to promote stabilization in the temperature of the sampled before tempering. Next, the samples were cooled to 27.7° C., kept in this temperature for 10 minutes and heated again to 31° C. for 3 minutes, as presented in table 16. During the tempering tests, kept in a controlled environment at 20.0 degrees Celsius+/−1 degree Celsius.

TABLE 16
Conditions used in the tempering process

| Crystallization | | | Reheating |
|---|---|---|---|
| temperature Tc | Crystallization | Reheating temperature | temperature |
| (° c.) | time Tc (° c.) | Tr (° c.) | tr (min) |
| 27.7 ± 0.5 | 10 | 31.0 ± 0.5 | 3 |

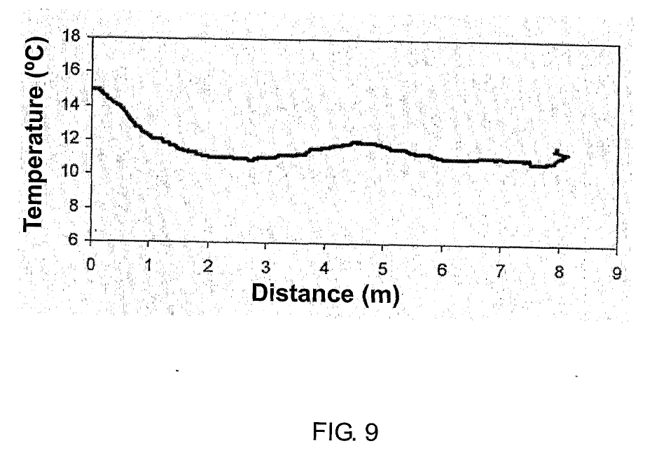

The tempered samples were deposited in pre-heated molds and cooled in a cooling tunnel according to the temperature profile presented in FIG. 9. The chart shows the cooling temperature of the air (° C.) along the belt inside the tunnel (m). During the tests were collected samples for the analysis of crystallization level (Temperindex TI).

The mold removing stages and packing were made at 20±1.0° C. The chocolate bars were packed in aluminum paper and kept in a hermetic recipient, protected from humidity and light, within a chamber at controlled temperature of 20±1.0° C. for a period of 15 days.

### Characterization of the Samples and Methodologies

The samples were characterized in terms of the maximum size of the particle, viscosity and flowing limit (Casson), humidity level, objective snap test analysis and crystallization level (Temperindex—TI). Also performed sensorial analysis consisting of Acceptance Test. All results were subject to variance analysis (ANOVA) and Tukey test to define the significant different between the averages of results using SAS program (Statistical Analysis System, 1993). Next, the methodologies used are presented.

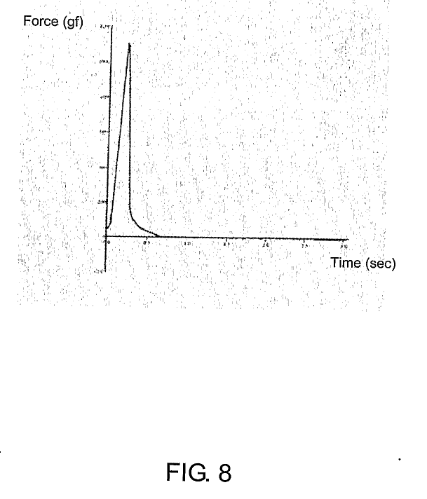

Maximum particle size (LUCCAS, 2001)—Used a digital MITUTOYO micrometer with scale of 0 to 250 mm, which was verified/calibrated before each measurement. For each sample were taken 3 portions from different regions which were diluted in pure Nujol brand mineral oil of 1:1 (in weight) and mixed manually until acquiring homogenous consistence. 10 measurements were performed for each chocolate.
Humidity level—(PR05KY, 2000)—Measured through direct determination by Karl Fischer. About 0.4 grams of chocolate were weighed in an analytical scale and dissolved in chloroform:methanol solution (1:1) Then proceeded to concentrate with Karl Fischer reagent using the Titroline Alpha/5chott-Gerate GmbH TM 125 concentrator. Determination was made in triplicate.
Viscosity and Casson flowing limit—(IOCCC, 1973) used a digital programmable rheometer, BROOKFIELD brand, model RVDVIII+, equipped with adaptor for small samples. The spindle used in the measurements was of the cylindrical type (specifications: S15), in relation to internal and external cylindrical radii of 0.75. The adaptor was coupled to a thermostat controlled immersion, BROOKFIELD brand, model TC500, and the temperature was kept at 40° C.±0.5° C. during readings. The measurements were performed using the rotation program presented in table 4 (VI550TTO et ai., 1997). With the results obtained, curves were built correlating the rate and tension of shearing and Casson parameters were calculated through linear regression according to the illustrative example of FIG. 8. Three repetitions were made for each sample.

TABLE 17
Program used in Rheometer BROOKFIELD RVDVIII+

| Time | | Revolution (rpm) |
|---|---|---|
| 3 | min* | 5 |
| 3 | min** | 50 |
| 3 | s | 100 |
| 6 | s | 50 |
| 15 | s | 20 |
| 30 | s | 10 |
| 60 | s | 5 |
| 30 | s | 10 |
| 15 | s | 20 |
| 6 | s | 50 |
| 3 | s | 100 |

VISSOTTO et al., 1997
*Uniformization of sample temp.
**Sample pre-shearing

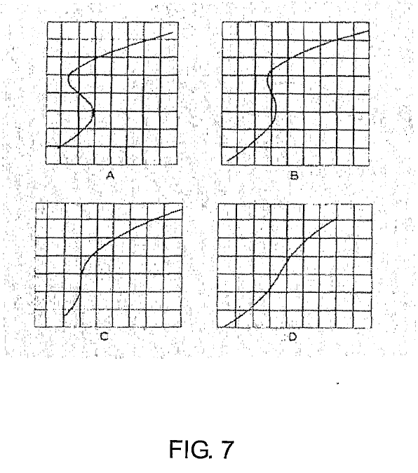

Crystallization level—Temperindex (TI)—For the analysis of the crystallization level, a SOLLICH model E3 temper meter was used. The temperate samples were characterized according to the cooling curve (FIG. 7).
Snap test—The analyses were performed in a Universal Texture meter TA-XT2i, of Stable Micro Systems, with attached software using probe HDP/3PB —THREE POINT BEND RIG. The conditions used for the analysis were:
Dimension of the chocolate bars: 8.2×2.5×0.7 cm
Bar paste: 19.75±1.64 g (standard)/20.34±1.27 g (Light)
Distance between probe bases: 6 cm
Distance between the probe and the sample: 5.5 cm
Pre-test speed: 3 mm/s
Test speed: 1.7 mm/s
Post-test speed: 10 mm/s

The parameter evaluated was the maximum snap force applied to the center of the bars, expressed in kgf, obtained through recording of the force×time curve, according to example presented in FIG. 8. The determinations were made in a temperature controlled environment at 25° C. 10 repetitions were made for each sample.

Sensorial analysis—Consisted in an Acceptance test performed with 9 tasters, consumers of bar chocolate. The samples were evaluated in terms of: Hardness to bite, melting, fatty residue and flavor. A hedonic scale of nine points was used with openings for general remarks on the products. In addition to the indicated attributes, each taster gave a general grade for each sample.

### Results and Discussion

Table 18 shows the results of the humidity analyses and the maximum particle size of milk chocolate samples standard (w/o collagen), and light (w/collagen). The rheological parameters are presented on Table 18, along with the average correlation coefficients obtained.

TABLE 18
humidity and maximum size of particle

| | Humidity | Maximum size of |
|---|---|---|
| Sample | (%) | particle (μm) |
| Standard chocolate | 0.95 ± 0.04 b | 22.60 ± 1.28 a |
| Chocolate - light in fats | l.32 ± 0.05 a | 22.10 ± 0.24 a |
| and light in calories | | |
| MDS | 0.019 | 1.11 |

M.D.S: Minimum Relevant Difference
Values of the same column with the same letter do not substantially differ from each other through Tukey test by 5% of relevance.

TABLE 19
Rheological parameters and coefficients of average correlation

| Sample | ηca (Pa · s) | ca (PA) | R² |
|---|---|---|---|
| Standard chocolate | 5.40_{— ± 0.01 b} | 1.20 ± 0.02 a | 0.99 |
| Chocolate - light in | 11.02_{— ± 0.09 a} | 0.54_{— ± 0.00 b} | 0.99 |
| fats and light in | | | |
| calories | | | |
| MDS | 0.15 | 0.05 | |

M.D.S: Minimum Relevant Difference
Values of the same column with the same letter do not substantially differ from each other through Tukey test by 5% of relevance.

It can be on table 18 that though there was statistically significant difference of up to 55 for the humidity level, the humidity values and maximum size of the particle of the two samples stayed within the ranges considered suitable for chocolate, i.e. 1.0% to 1.5% and 20 μm to 25 μm, respectively. This indicates that the conditions of the process used in the tests were suitable, above all the adjustment of the refiner and the temperature and time of shelling. It is important to point out that the replacements of sugar [e.g. polydextrose] present high water absorption capacity (GOMES et al., 2007), which requires extra studies to select the packing of the end product. As already verified for light-in-fat chocolate (project 118/05) replacement in part of cocoa butter by hydrolyzed collagen HIDROGEL® in the proportion of 4.94% and the consequent reduction of the lipidic level of the formulation of 30.00% for 22.44% caused an increase in the viscosity of the light in fat and light in calories chocolate according to table 19. There was also a reduction in PGPR level at the flowing limit probably due to the decrease of PGPR in the light formulation. Nonetheless, the values are within the admissible limits for the production of chocolates using the conventional process (VISSOTTO et al., 1997). Table 20 presents the results obtained in the tempering or pre-crystallizing of samples, while table 21 shows the results of the snap test of chocolate bars.

TABLE 20
Tempering or pre-crystallization of chocolate samples

| | Cooling Rate | Crystallization Level |
|---|---|---|
| Sample | (° C./min) | (Temperindex - TI) |
| Standard chocolate | 1.25 ± 0.18 a | 5.97 ± 0.13 a |
| Light-in-fat chocolate | 1.50 ± 0.15 a | 6.00 ± 0.50 a |
| and light in calories | | |
| MDS | 0.19 | 0.22 |

M.D.S: Minimum Relevant Difference
Values of the same column with the same letter do not substantially differ from each other through Tukey test by 5% of relevance.

TABLE 21
Snap test of chocolate samples

| Sample | Snap force (kgf)* |
|---|---|
| Standard chocolate | 1.94 ± 0.22 a |
| Chocolate light-in-fat and | 2.01 ± 0.17 a |
| light in calories | |
| MDS | 0.19 |

M.D.S: Minimum Relevant Difference
Values of the same column with the same letter do not substantially differ from each other through Tukey test by 5% of relevance.

Note in tabled 19 and 20 that no statistical differences of significance were identified at 5% for two chocolate samples in relation to the crystallization level and snap force respectively. Temper index values stayed within the range of 4 to 6, used for milk chocolate, indicating that industrially the tempering of milk chocolate light in fats and in calories can be performed using the traditional process used today for chocolates with cocoa butter or equivalent fats—CBEs (Cocoa Butter Equivalents): The similarity in the snap force values (table 21) show that the replacement of sugar with polyols and the incorporation of hydrolyzed collagen did not interfere in the snapping of chocolate, property considered important in the quality of the product, above all in chocolate tablets.

Table 22 shows the results of the sensorial evaluation. The hard-

[symbol]

| | | | |
|---|---|---|---|
| Proteins (g) | 6.49 | 6.89 | 12.01 |
| Total fats (g) | 30.27 | 30.00 | 22.44 |
| Saturated fats (g)) | 17.56 | 19.19 | 13.86 |
| Cholesterol (mg) | 5.00³ | 7.20 | 6.14 |
| Fibers (g) | <1 g/30 g³ | 2.10 | 15.10 |
| Calcium (mg) | 146.67³ | 204.32 | 234.39 |
| Iron (mg) | 1.63³ | 0.00 | 0.16 |
| Sodium (mg) | 66.67 | 67.11 | 81.07 |
| Caloric value (Kcal/100 g) | 532.44 | 528.12 | 390.86 |

¹Values subject to variations due to ingredient vendors/lots used;
²average values directly obtained from the labels of chocolates NESTLÉ, KRAFT and GAROTO;
³NESTLÉ chocolates

Comparing to the standard chocolate, it is verified that the light chocolate developed presents reduction of 25.20% in total fats level and 25.99% in caloric value. In reference to the average of total fat levels and caloric value of the 3 commercial samples chosen (NESTLE, KRAFT and GAROTO), of 30.27% and 532.44 Lcal/100 g, respectively, the light product presents reduction of 25.87% in total fat level and 26.i59% in caloric level. Therefore, as determined by Ordinance 27 of Jan. 13, 1998, ANVISA, the product can be declared as being light in total fats and light in calories (AN-VISA, 2007-BR).

In relation to the level of proteins (average of 6.49 g/100 g in the commercial samples), the light chocolate produced has 12.01 g/100 g, i.e. 85.05% more than when compared to commercial chocolates.

Although with 45.87% of carbohydrates, according to ordinance 27, the light chocolate can also be classified as a product without the addition of sugars, as all of the saccharose in the formulation was replaced by the polydextrose mixture, maltidol and sucralose. According to ordinance 29 of Jan. 13, 1998, ANVISA, item 4.1.1.1—Foods for diets with restriction of saccharose, fructose and or glucose (dextrose) are “foods especially formulated to meet the needs of people with sugar metabolism disorders. They can contain at most 0.5 g of saccharose, fructose and or glucose per 100 g or 100 ml of end product” (ANVISA, 2007-BR).

In terms of minerals, the light chocolate has a higher level of calcium and a lower level of iron than the NESTLÉ chocolate. It presented higher level of sodium when compared with the average commercial chocolates NESTLÉ (zero) and GAROTO (64 mg/100), and less than KRAFT chocolate (136 mg/100 g)). There is no specific legislation that limits the level of sodium in chocolates.

### CONCLUSIONS

The partial replacement of cocoa butter by hydrolyzed collagen HIDROGEL® and the substitution for the mixture of Polydextrose, maltidol and sucralose, allowed the obtainment of a milk chocolate with light appeals in fats and calories and w/o the addition of sugar. Depending on the level of saccharose, fructose and or glucose (dextrose), known by means of analyses, the product can also be classified as diet in sugars.

Comparing to commercial chocolates as reference (NESTLÉ, KRAFT and GAROTO), the chocolate developed presents reduction of 25.87% in total fats level, reduction of 26.59% in caloric value and increase of 85.05% in the level of proteins. It presents greater levels of calcium and sodium, and lesser level of iron. Depending on the country where it is sold and the effective legislation, the product can be considered as rich in fibers.

Having described examples of preferred realization, one should understand that the scope of the present invention includes other possible variations, limited only by the scope of the claims, including therein the possible equivalents.

1. Food composition characterized by comprising about 25% to 40% by weight of a composition of cocoa and/or derivates thereof, about 2% to 10% by weight of the fat-substitute protein and about 0.5% to 3% of an emulsifying agent, based on total weight of the composition.

2. A food composition according to claim 1, characterized in that the composition of cocoa comprises powdered cocoa, cocoa butter, cocoa liqueur and/or derivatives thereof.

3. A food composition according to claim 1, characterized by comprising a minimum of 20% by weight of cocoa solids in relation to the total weight of the composition.

4. A food composition according to claim 3, characterized by comprising a minimum of 25% by weight of total cocoa solids in relation to the total weight of the composition.

5. A food composition according to claim 1, characterized in that the fat-substitute protein comprises hydrolyzed collagen and/or its derivatives.

6. A food composition according to claim 5, characterized in that the fat-substitute protein comprises hydrolyzed collagen with a molecular weight of up to 50,000 Da.

7. A food composition according to claim 6, characterized in that the molecular weight of the hydrolyzed collagen ranges from 500 to 30,000 Da.

8. A food composition according to claim 7, characterized in that the molecular weight of the hydrolyzed collagen ranges from 1,500 to 20,000 Da.

9. A food composition according to claim 1, characterized in that the emulsifying agent comprises soy lecithin, polyglycerol polyricinoleate (PGPR), one or more fatty acid esters, sorbitan polystyrene monostearate, one of more ammonia salts of phosphatidic acid, one or more ricinoleic acid esters interesterified with polyglycerol, sorbitan monostereate and sorbitan tristearate or mixtures thereof.

10. A food composition according to claim 9, characterized by comprising emulsifying agents with about 0 to 0.5% by weight of PGPR and about 0 to 3% of soy lecithin in relation to the total weight of the composition.

11. A food composition according to claim 10, characterized in that the composition further comprises a milk component and/or a derivative thereof.

12. A food composition according to claim 11, characterized in that the milk component and/or derivative thereof comprises cow's milk, whole milk, semi-skimmed milk, soybean milk, condensed milk or mixtures thereof.

13. A food composition according to claim 12, characterized by further comprising ground sugar, granulated sugar, fructose, glucose, aspartame, sorbitol, xilose or mixtures thereof.

14. A food composition according to claim 13, characterized by comprising between 18 and 30% by weight of fat with respect to the total weight of the composition.

15. A food composition according to claim 14, characterized by having moisture contents ranging from about 0.9 to 1.2% by weight in relation to the total weight of the composition.

16. A food composition according to claim 15, characterized by comprising between 2 and 16% by weight of protein with respect to the total weight of the composition.

17. A food composition according to claim 16, characterized by comprising a caloric value between 115 and 150 kcal per portion of 30 g of product.

18. A food composition according to claim 17, characterized by having one of the following characteristics:
water activity ranging from about 0.36 to 0.39%;
particle size ranging from about 20 to 25 μm;
fracture force ranging from about 2 kgf to 2.6 kgf;
Casson's plastic viscosity ranging from about 4.5 Pa·s to 11 Pa·s;
flow limit ranging from about 0.3 to 2.6 Pa;
crystallization degree ranging from about 5.0 to 7.0.

19. A food composition according to claim 1, characterized by being a chocolate.

20. A food composition according to claim 19 characterized by being a milk chocolate or white chocolate.

21. Use of an effective amount of composition of cocoa and/or derivatives thereof, a fat-substitute protein and emulsifying agents, characterized in that it is used for preparing a food composition as defined in claim 20.

22. A food composition characterized by comprising about 25% to 40% by weight of a composition of cocoa and/or derivative thereof, about 1% to 10% by weight of fat-substitute protein, about 0.1% to 5% by weight of emulsifiers, about 0.5% to 70% by weight of body agent and 0.01 to 0.09% by weight of edulcorant, in relation to the total weight of the composition.

23. A food composition according to claim 22, characterized in that the composition of cocoa and/or derivative thereof comprises powdered cocoa, cocoa butter, cocoa liqueur and/or derivatives thereof.

24. A food composition according to claim 23, characterized by comprising a minimum of 20% by weight of cocoa solids in relation to the total weight of the composition.

25. A food composition according to claim 24, characterized by comprising a minimum of 25% by weight of total cocoa solids.

26. A food composition according to claim 22, characterized in that the fat-substitute hydrolyzed protein is hydrolyzed collagen and/or derivatives thereof.

27. A food composition according to claim 26, characterized in that the fat-substitute protein comprises hydrolyzed collagen having a molecular weight of up to 50,000 Da.

28. A food composition according to claim 27, characterized in that the molecular weight of the hydrolyzed collagen ranges from 500 to 30,000 Da.

29. A food composition according to claim 22, characterized in that the molecular weight of the hydrolyzed collagen ranges from 1,500 to 20,000 Da.

30. A food composition according to claim 22, characterized in that the emulsifiers comprise soybean lecithin, polyglycerol polyricinoleate (PFPR), fatty acid esters, sorbitan polyoxyethylene monostearate, phosphatidic acid ammonium salts, esters of ricinoleic acid interesterified with polyglycerol, sorbitan monostearate and sorbitan tristearate or mixtures thereof.

31. A food composition according to claim 30, characterized by comprising emulsifying agents with about 0 to 0.5% by weight of PGPR and about 0 to 3% of soybean lecithin in relation to the total weight of the composition.

32. A food composition according to claim 22, characterized in that the edulcorants are selected from the group consisting of sucralose, acesulfame-K, aspartame, saccharin, cyclamate, stevioside, and mixtures thereof.

33. A food composition according to claim 22, characterized in that the body agent is selected from the group consisting of polyols, polydextrose, lactitol, maltitol, sorbitol, fructoligossacaharide, isomalte, and mixtures thereof.

34. A food composition according to claim 22, characterized by comprising a milk component and/or milk-derivative component.

35. A food composition according to claim 34, characterized by further comprising about 0% to 30% by weight of a milk component and/or a milk-derivative component.

36. A food composition according to claim 35, wherein the milk or milk-derivative component is selected from the group consisting of skimmed milk, whole milk, semi-skimmed milk, whey, milk substitutes, cow's milk, soybean milk, condensed milk, and mixtures thereof.

37. A food composition according to claim 36, characterized by further comprising malt extract.

38. A food composition according to claim 37, characterized by comprising about 18% to 30% by weight of total fat, in relation to the total weight of the composition.

39. A food composition according to claim 38, characterized by comprising 5% to 50% by weight of vegetable, animal and substitute fats and/or fats similar to cocoa butter in relation to the total weight of the composition.

40. A food composition according to claim 39, characterized by having a caloric value ranging from about 50 to about 150 kcal in each portion of 30 g of the composition.

41. A food composition according to claim 40, characterized by being light in fat and with a reduced calorie value.

42. A food composition according to claim 39, characterized by being a chocolate.

43. A food composition according to claim 42, characterized by being a milk chocolate or white chocolate.

44. Use of an effective amount of a composition of cocoa and/or derivatives thereof, fat-substitute hydrolyzed protein, emulsifiers, edulcorants, and body agents, characterized in that is used for preparing a food composition as defined in claim 42.

45. Product characterized by comprising a food composition as defined in claim 1.
